(19) United States
(12) Patent Application Publication
(10) Pub. No.: US 2005/0008264 A1
(43) Pub. Date: Jan. 13, 2005

(54) Image displaying method and apparatus, and program for the same

(76) Inventors: Takayuki Iida, Kanagawa (JP); Yoichi Nakamura, Kanagawa (JP); Masaki Takamatsu, Kanagawa (JP); Shizuo Habuta, Tokyo (JP); Tatsuya Konagaya, Kanagawa (JP)

Correspondence Address: BIRCH STEWART KOLASCH & BIRCH, PO BOX 747, FALLS CHURCH, VA, 22040-0747, US

(21) Appl. No.: 10/885,770

(22) Filed: Jul. 8, 2004

(30) Foreign Application Priority Data
Jul. 9, 2003 (JP) 2003-194018

(51) Int. Cl. G06K 9/60; G06F 17/30; G06F 17/00

(52) U.S. Cl. 382/305; 382/306; 707/3; 707/104.1

(57) ABSTRACT

Image frames are displayed on a display panel, in order to output image data of the image frame selectively. In an image displaying method, image data of plural image frames related to a user are read from a storage DVD. Birthdate information of the user is input. Developmental period information of plural developmental periods is preset, which are consecutive in a sequence in a personal history manner. A date of photography of the image data is evaluated according to the birthdate information and the plural developmental periods, so association of the plural developmental periods with the image frames is determined in relation to the user, to sort the image frames. One of the plural developmental periods is selected. Sorted image frames are displayed on the display panel, which are sorted with the selected developmental period among the image frames.

### BACKGROUND OF THE INVENTION

1. Field of the Invention

The present invention relates to an image displaying method and apparatus, and a program for the same. More particularly, the present invention relates to an image displaying method and apparatus, and a program for the same, with which image data of image frames are output selectively, a user can select image frames from a considerable number of stored image frames, so as to reproduce the selected image frames as a set of prints suitably according to intention of the user.

2. Description Related to the Prior Art

An imaging system is suggested in U.S. Pat. Nos. 6,346,998 and 6,657,753 (both corresponding to JP-A 10-150538), in which a scanner or other reader is used to read image frames from a negative photo film or photographic prints, to output digital signals. Data of the image frames are processed and written to a storage medium, for example, CD-R and DVD-R. Image data stored in the storage medium is read one frame after another by a reproducing device, such as a personal computer. Thus, a user is enabled to observe the image frames displayed on a display panel.

The number of the image frames displayed on the display panel is limited according the panel size. It is necessary for the user to operate a cursor, mouse or suitable pointing device for shifting and displaying intended ones of the image frames on the display panel by scrolling. If the number of the image frames stored in the storage medium is extremely high, there is a problem in much time and labor in searching the image frames by reviewing and comparing scenes with care.

In general, information of a photographing date is output at the time of taking a photograph, and recorded on a surface of the negative photo film or photographic prints. For the digital imaging, the photographing date information is read from those, so as to sort or classify the image frames according to the years of the photography. The image frames are searchable by addressing the photographing date as key words. This is effective in searching the image frames for the intention of the user with high efficiency.

A recollection of an event in a personal life is likely to be unclear and difficult according to the length of time passed after the occurrence. Most of the users feels difficulty in remembering their past scenes in the life precisely according to the sequence of time. Even when the user wishes digitization of very old phonographs or negative photo film, it is likely that the user cannot recollect the age or period of the image frames. The photographing date is available but is not useful in a form relevant to the remembrance of the user. The image frames cannot be selected in a suitable manner for the intention in utilizing the photographing date.

### SUMMARY OF THE INVENTION

In view of the foregoing problems, an object of the present invention is to provide an image displaying method and apparatus, and a program for the same, in which image frames can be displayed after search from a great number of stored image frames with high efficiency, and easily with the reminiscence and association of a user.

In order to achieve the above and other objects and advantages of this invention, an image displaying method is provided, in which terms associated with respectively human developmental periods are determined according to a birthdate, birth month or birth year of a user. Image frames are sorted for the developmental periods according to chronological information of the image frames by referring to the terms, wherein image data of the image frames are stored in a storage medium, and the chronological information is stored in the storage medium in association with the image frames. Image frames associated with a selected one of the developmental periods are read from the storage medium, so as to display the read image frames on a display panel.

Displaying the image frame on the display panel is in order to output the image data of the image frame selectively.

Furthermore, the developmental period information of the plural developmental periods is displayed on the display panel, wherein the plural developmental periods are adapted to the designating step, and a selected one of the sorted image frames sorted with the selected developmental period is designated and output.

Furthermore, time axis information of a calendrical time axis is displayed on the display panel, the developmental period information of the plural developmental periods being arranged on the time axis.

Furthermore, plural featured image frames having a calendrically fixed year, date or time are read. The plural featured image frames are displayed on the display panel in association with the developmental periods, the plural featured image frames being referred to for designation of the selected developmental period.

Furthermore, a graduation pattern is displayed on the display panel along the time axis at a regular pitch that represents a predetermined unit period.

The user comprises plural users, and the developmental periods are determined for respectively the plural users.

Furthermore, a selected one of the featured image frames is designated. Information of a plurality of the unit period is displayed on the display panel according to a calendrically fixed year, date or time of the selected featured image frame. At least one principal image frame is displayed on the display panel for each of the plural unit periods among the sorted image frames. A selected one of the plural unit periods is designated by referring to the principal image frame. At least one sorted specific image frame is displayed on the display panel, the sorted specific image frame being sorted with the selected unit period.

Information of the plural featured image frames is read from a memory, or is input by communication with an image server.

The unit period is equal to or more than one month, and equal to or less than five years.

Furthermore, at least one developmental period principal image frame for each of the plural developmental periods is displayed on the display panel among the sorted image frames, the developmental period principal image frame being referred to for designation of the plural developmental periods.

The developmental period information extends in an arrangement to surround or cover the developmental period principal image frame.

The image data are obtained by optical reading of the image frames on photo film or a photographic print, and the chronological information is obtained by reading from an information portion of the photo film or the photographic print.

Furthermore, frame amount information is displayed on the displaying panel, for representing an amount of the image frames per the unit period or per the developmental periods.

The frame amount information has a number form or letter form.

The frame amount information has a patterned form or indicia form having a size or shape according to the amount to be represented.

According to another aspect of the invention, an image displaying method includes inputting birthdate, birth month or birth year information of a user. Developmental period information of plural developmental periods is preset, which are consecutive in a sequence in a personal history manner. Time axis information of a calendrical time axis is displayed on the display panel. A calendrically fixed year, date or time of the plural developmental periods is determined on the time axis in relation to the user according to the birthdate, birth month or birth year information, to display the developmental period information on the display panel. Plural featured image frames are displayed on the display panel in association with the plural developmental periods, the plural featured image frames having a calendrically fixed year, date or time on the time axis.

Furthermore, a program for executing processes by running a computer, wherein an image frame is displayed on a display panel for the same purpose is provided. Also, an image displaying apparatus of displaying an image frame for the same purpose,

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating an imaging system and a digitizing process of the invention;

FIG. 2 is a block diagram illustrating structure of data stored in a DVD;

FIG. 3 is a front elevation illustrating a menu where frame amount information of image frames is displayed for unit periods;

FIG. 4 is a flow chart illustrating a displaying process of displaying the image frames by developmental periods;

FIG. 5 is a front elevation illustrating a menu where the image frames are sorted by the developmental periods;

FIG. 6 is a front elevation illustrating a menu where retrospection image frames are displayed;

FIG. 7 is a front elevation illustrating a menu where image frames of the user are arranged with the retrospection image frames;

FIG. 8 is a front elevation illustrating data stored in a retrospection image database storage;

FIG. 9 is a front elevation illustrating another preferred menu where the image frames are sorted by the developmental periods;

FIG. 10 is a front elevation illustrating still another preferred menu where the image frames are sorted by the developmental periods;

FIG. 11 is a front elevation illustrating a preferred embodiment where developmental period information of two users are displaying at the same time.

### DETAILED DESCRIPTION OF THE PREFERRED EMBODIMENT(S) OF THE PRESENT INVENTION

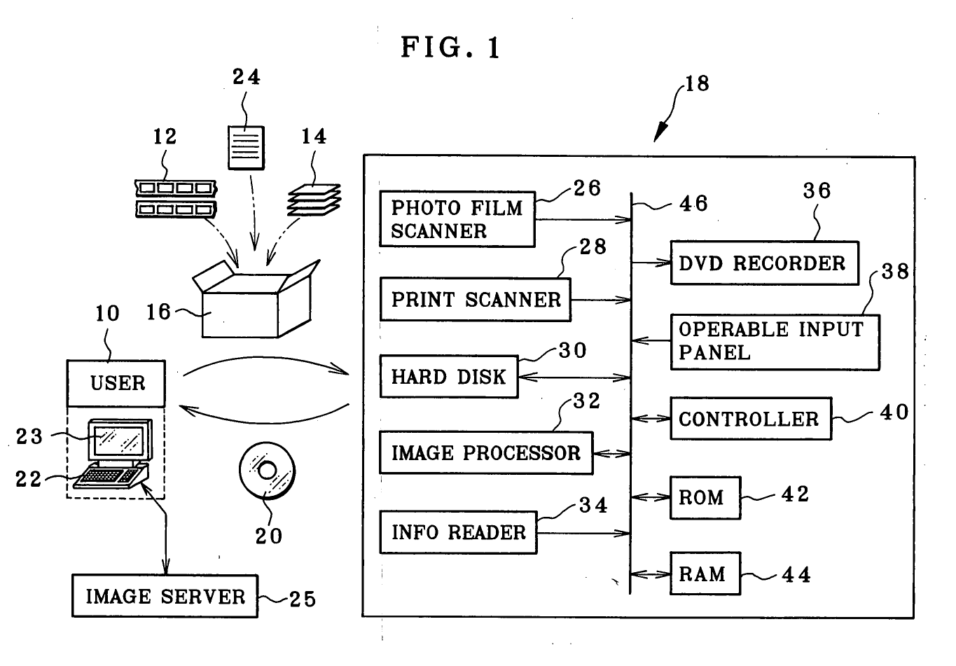

Preferred embodiments of the invention are described by referring to the drawings. In FIG. 1, a user 10 packages his or her negative photo film 12, photographic prints 14 with images, and the like into a case, to produce a user order package 16, which is forwarded to a dealer or photofinisher having a digital imaging system 18 at a digital imaging center. The digital imaging system 18 includes equipment, which reads information from the negative photo film 12 or the photographic prints 14 of the user 10 to produce image data, and writes the image data to a DVD (digital versatile disk) 20 as a storage medium. The DVD 20 is supplied to the user 10. After this, a personal computer 22 at the user 10 is located with the DVD 20, the personal computer 22 having a computer main unit and a keyboard. The user 10 can view images by playing the DVD 20 as storage medium.

A user order form 24 is included in articles inserted in the user order package 16 that the user 10 sends to the digital imaging system 18 as well as the negative photo film 12, the photographic prints 14 or the like. The user order form 24 has spaces for filling in user information of the user 10, including his or her name, address, birthdate, telephone number, electronic mail address, and members of the family. As the user 10 fills in the user order form 24 with the user information, the user information is transmitted to the digital imaging system 18.

The digital imaging system 18 includes a photo film scanner 26, a print scanner 28, a hard disk 30, an image processor 32, an information reader 34 for user information, a DVD recorder 36, an operable input panel 38, a ROM 42 and a RAM 44. A controller 40 controls those elements in the digital imaging system 18. There is a data bus 46 for connecting those relevant elements with one another in the digital imaging system 18.

The photo film scanner 26 successively reads image frames from the negative photo film 12 at a predetermined resolution, and obtains image data of the image frames. The image data are provided with specific data file names, for example ALBUMi.jpg, where i is a serial number, and are written to the hard disk 30.

The photo film scanner 26 reads images from the negative photo film 12, and also reads date information of a date of photographing an image frame with digits of a month, day and year. Note that a code number, such as a DX code, is prerecorded on the negative photo film 12 to represent a particular type of the negative photo film 12. The DX code is read from the negative photo film 12, and evaluated by referring to a date database stored in the hard disk 30. Thus, it is possible to estimate the period of the production of the negative photo film 12 as its date information.

If the negative photo film 12 is the APS type of photo film, there is a magnetic recording region disposed on the outside of image frames, for magnetic recording of photographing information, of which examples are a date of the exposure, and other items related to taking the exposure. Reading of the magnetic information in the magnetic recording region enables inputting and recognizing of the date information.

An image included in those on the negative photo film 12 may include portions with numbers or letters to indicate the photographing date. For such a frame, it is possible to detect the date information by subjecting the portion with the date to the character recognition. Note that it is likely for an image frame to have an unclear form of the photographing date within the image due to an unsharp state, over or underexposed state or the like. For such a frame, it is possible to read clear forms of date information from directly preceding and succeeding image frames, and to estimate the date information according to the neighboring dates of those image frames.

The print scanner 28 produces image data by reading image frames recorded on the photographic prints 14, assigns specific data file names to the image data, and writes the image data to the hard disk 30. Note that an image in the photographic print 14 may include portions with numbers or letters to indicate the photographing date. For such a frame, the number or letter portions are subjected to the character recognition, to detect the photographing date.

If the photographic print 14 has an image of a margin-formed shape without full-width printed form, the photographic print 14 may have chronological information in a margin region to represent the year of the printing, such as “Fujicolor 99”. Also, a back surface of the photographic print 14 may be provided with information of the year. For such forms of information, it is possible to read the margin region or the back surface of the photographic print 14. Furthermore, the obtained information can be subjected to the character recognition, to obtain date information according to the numbers or letters being recognized.

The controller 40 produces an index file constituted by association of the date information output by the photo film scanner 26 or the print scanner 28 with the image data files. The index file is written to RAM 44, and renewed by overwriting at each time of reading of image frames.

The image processor 32 is supplied with image data produced by the photo film scanner 26 or the print scanner 28, and subjects the image data to image processing of items including gradation processing, color conversion processing, sharpness processing and the like, to obtain processed image data. It is also possible in the image processor 32 to effect image compensation processing of the image, for example, color fading correction for reproduction by eliminating sepia-tinted state, correction of scratches, and red-eye phenomenon correction.

The information reader 34 optically reads the user information recorded on the user order form 24. Examples of the information reader 34 include a bar code reader, a mark sheet reader, an optical character recognizing device (OCR) and the like. The user information read by the information reader 34 is stored in RAM 44. Note that it is possible for an operator to input the user information from the user order form 24 manually by operating the operable input panel 38 instead of the optical reading of the user information.

The DVD recorder 36 records information to the DVD 20, the information including image data files in the hard disk 30, an index file stored in RAM 44, a viewing program for viewing images, and the like. In place of the DVD 20, it is possible to use CD-R, MO, optical card and other media. For such media, it is possible to use a CD-R drive, an MO drive, an optical card writer and the like instead of the DVD recorder 36.

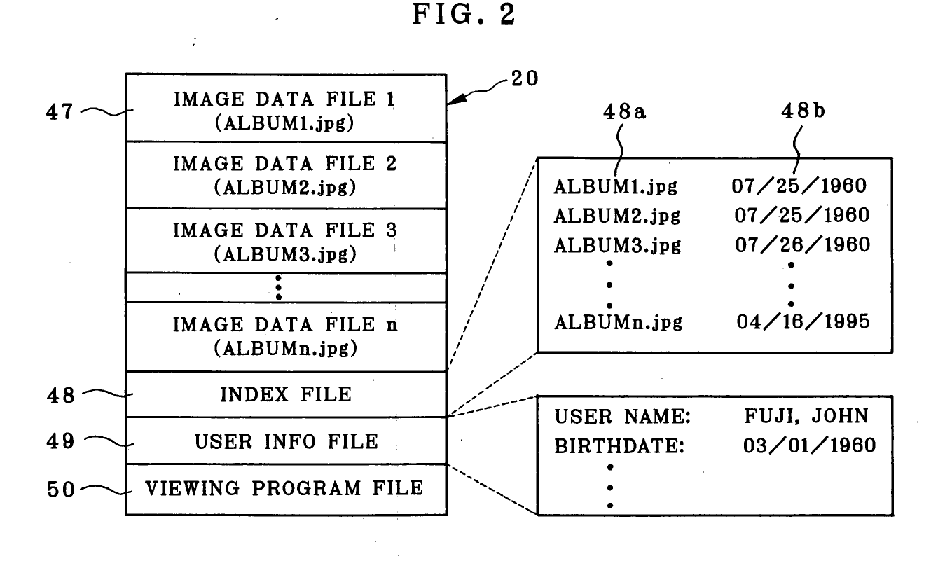

In FIG. 2, various data files are written to the DVD 20, including image data files 47, an index file 48, a user information file 49, and a viewing program file 50. The image data files 47 are provided with specific data file names, for example ALBUMi.jpg, which are adapted to discernment of image frames read from the negative photo film 12 or the photographic prints 14.

Information of the index file 48 includes image data file name information 48a and date information 48b associated with the image data file name information 48a. An order of arranging the index file 48 is chronological according to the date information 48b. As will be described later, the date information 48b is used for sorting or grouping the image data files 47 according to calendrical periods or personalized developmental periods. Also, the index file 48 can include other information, for example photo film type information, scene information, fading correction information, scratch correction information, red-eye correction information, APS-CHP information, 135-FHP information, printing size information, pixel number information, and the like.

The user information file 49 is constituted by the user information filled in the user order form 24 and read by the information reader 34, the user information including the birthdate information and the user name information. A display panel 23 is connected with the personal computer 22, and displays images by running the viewing program file 50 and reading the image data files 47. Initially, ROM 42 in the digital imaging system 18 stores the viewing program file 50, which is transmitted to the DVD recorder 36 at the time of recording to the DVD 20.

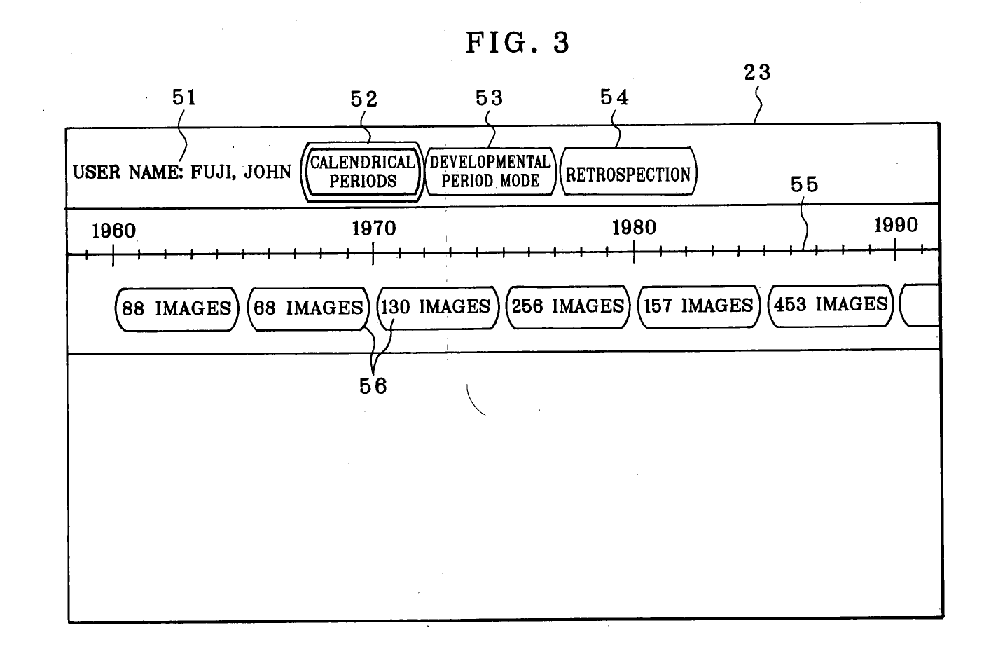

The DVD 20 storing the image data files 47 and the like is sent from the digital imaging system 18 to the user 10. A DVD drive in the personal computer 22 is loaded with the DVD 20, to read the viewing program file 50 to run the viewing program. Then the index file 48 and the user information file 49 are read. A startup menu of FIG. 3 is displayed on the display panel 23.

There are patterned regions of user name information 51, a calendrical period button 52, an developmental period mode button 53, and a retrospection image button 54 or featured image button pattern, which are arranged horizontally. A calendrical time axis 55 extends under those button patterns. Frame amount buttons 56 as a button pattern are arranged horizontally under the time axis 55, and indicate image frame amounts of image frames per calendrical period of time, for example five (5) years. According to the date information 48b included in the index file 48, the image data files 47 are grouped or sorted per calendrical period of time, for example five (5) years. The numbers of the image frames belonging to the calendrical periods are counted, to obtain image frame amount information associated with respectively the calendrical periods. Then a desired one of the frame amount buttons 56 is clicked and selected by operation the keyboard or mouse at the personal computer 22, to read the image data files 47 from the DVD 20 according to the date information associated with the calendrical period of the desired one of the frame amount buttons 56. Thumbnail image frames are displayed and arranged in a space under the frame amount buttons 56.

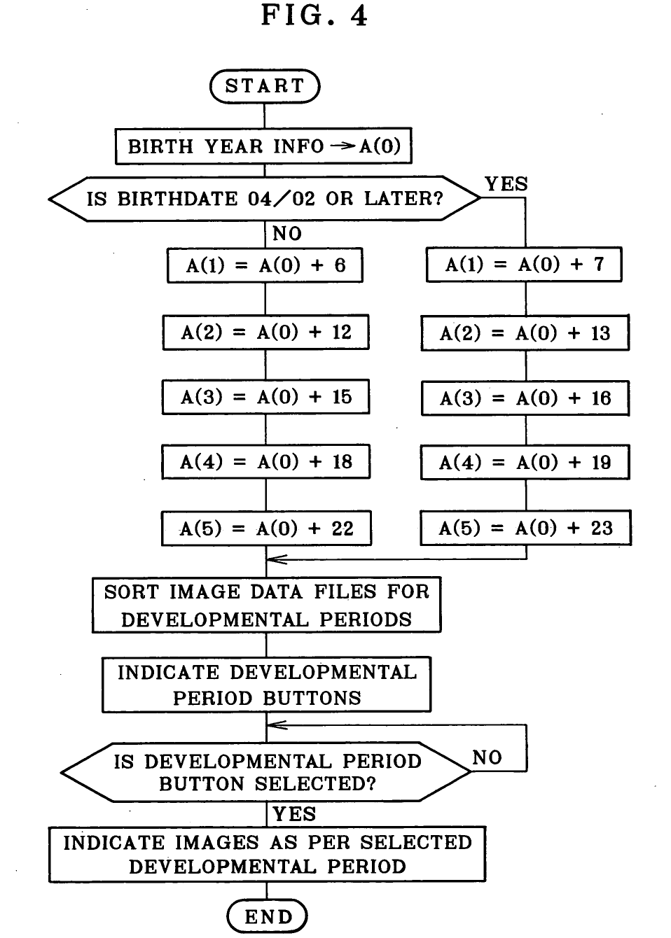

In operation, when the calendrical period button 52 is clicked by the user 10 or a certain person at the personal computer 22, the image data files 47 stored in the DVD 20 are grouped or sorted according to the set of developmental periods and the birthdate information of the user 10, the developmental periods including the childhood period, primary school period, junior high school period, high school period, college period, and adulthood period. As illustrated in the flow chart of FIG. 4, the birthdate information is read from the user information file 49. Year data of the birth year of the user 10 is stored at an address of A(0) in a memory of the personal computer 22. Other year data are calculated according to the birth year data A(0), the other year data including: year data A(1) of the year of entrance to the primary school, year data A(2) of the year of entrance to the junior high school, year data A(3) of the year of entrance to the high school, year data A(4) of the year of entrance to the college, and year data A(5) of the year of grown-up or entrance to an office as a worker. For example, A(1)=A(0)+6, because the entrance of the user 10 to the primary school is at the age of six (6).

If two persons or users have a common value of the birth year data A(0), there are two possibilities of the year of entrance to a primary school, junior high school or the like. According to a compulsory education system publicly used in a country or a local region, a child enters a primary school in the school year of 1966 if his or her birthdate is on or before Apr. 1, 1960. Another child enters the primary school in the school year of 1967 if his or her birthdate is Apr. 2, 1960 or later. Consequently, values of A(1) to A(5) for a user having the birthdate of April 2 or later is determined greater by one (1) than values of those for a user having the birthdate of April 1 or earlier.

Then the image data files 47 read from the DVD 20 are sorted for each of the developmental periods according to the year data from A(0) to A(5). If data files included in the image data files 47 have the date information within a term beginning on the birthdate of the user 10 and ending on March 31 of the year of the year data A(1), then the data files are determined as associated with the childhood period. If data files included in the image data files 47 have the date information within a term beginning on April 1 of the year of the year data A(1) and ending on March 31 of the year of the year data A(2), then the data files are determined as associated with the primary school period. Similarly, the image data files 47 associated with each of the developmental periods are determined, the developmental periods including the junior high school period, the high school period, the college period, and the adulthood period.

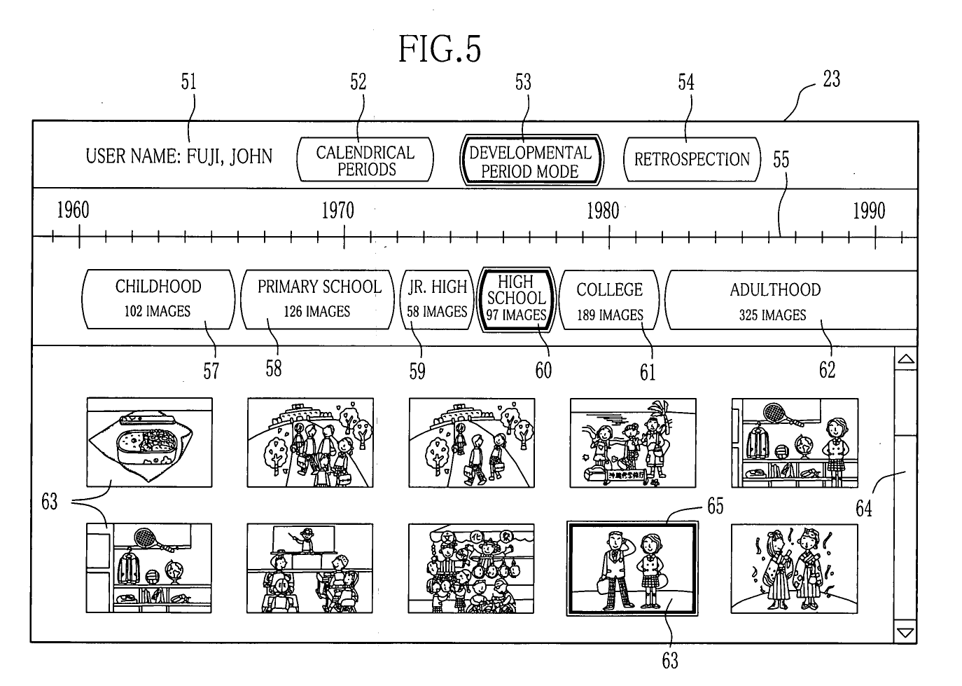

In FIG. 5, patterns of developmental period buttons 57, 58, 59, 60, 61 and 62 or developmental period information are displayed under the time axis 55 after sorting the image data files 47 according to the developmental periods. Letters or words of CHILDHOOD, PRIMARY SCHOOL and the like are indicated in the developmental period buttons 57-62. Also, numbers of image frames associated with the developmental periods are indicated in the developmental period buttons 57-62. The developmental period buttons 57-62 being arranged vertically next to the time axis 55, each developmental periods specified personally for the user 10 can be indicated in a clarified manner. The user 10 can be reminded of his or her childhood period, primary school period, junior high school period, high school period, college period, and adulthood period.

The user 10 observes the developmental period buttons 57-62 arranged in one line, and selected a desired one of them according to his or her interest. If the developmental period button 60 for the high school period is selected, data files associated with the period according to the year data A(3) and A(4) are read from the DVD 20 among the image data files 47, so thumbnail image frames 63 are displayed on the display panel 23 in one line. There is a scroll bar 64 indicated on a right-hand lower corner of the panel. If the user 10 clicks the scroll bar 64, a displayed image can be scrolled to show a hidden group of the thumbnail image frames 63 no matter how many the thumbnail image frames 63 are. The user 10 manually operates a keyboard, mouse or other input devices of the personal computer 22, and shifts a cursor key or cursor 65 to one of image frames on the display panel 23, the cursor 65 operating as a pointing device of an operable input. A confirmation key or printing key (not shown) is operated, so that the one image frame is quickly enlarged in the display panel 23, or immediately output as a print image.

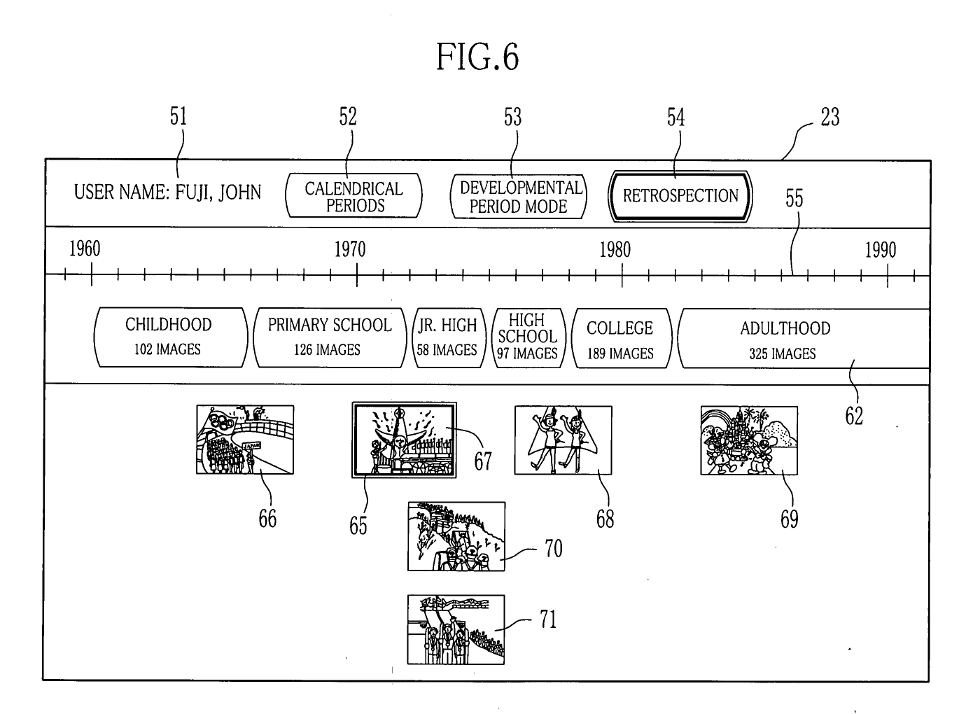

When the developmental period mode button 53 is selected, retrospection image data files are read from the viewing program file 50. In FIG. 6, retrospection image frames 66, 67, 68, 69, 70 and 71 or featured image frames are displayed on the display panel 23. The retrospection image frames 66-71 are preset images, are unrelated to specific users, and widely popular as reminiscence of scenes of past events or incidents in the society. The viewing program file 50 previously stores data files of those, and also date information of past dates of occurrence of the scenes. One purpose of the retrospection image frames 66-71 is to make it easy for a user to recollect his or her personal events or incidents by considering association of the past social events or incidents with one personal history. The user 10 shifts the cursor 65, and clicks and selects his or her desired one of the retrospection image frames. Note that the retrospection image frame 66 has an image of 1964, and the retrospection image frame 69 has an image of 1983.

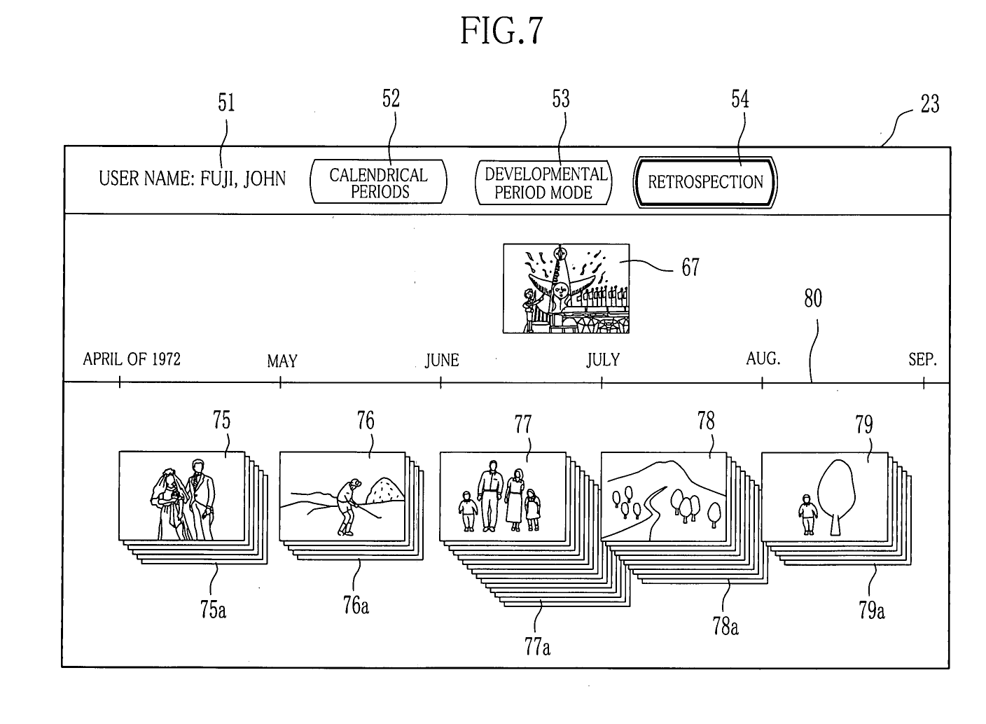

For example, the retrospection image frame 67 with one scene of the Japan World Exposition at Osaka in 1970 is selected. In FIG. 7, the retrospection image frame 67 is indicated clearly together with a calendrical time axis 80 as axis information. A smallest unit or graduation of the time axis 80 is one month. The retrospection image frame 67 is displayed nearly at the center of the display panel 23 in such a manner that the month of occurrence of the retrospection image frame 67 corresponds to the time axis 80.

Among the image data files 47, data files having date information within a range indicated with the time axis 80 are read, and grouped for the respective months as unit period. Then principal image frames 75, 76, 77, 78 and 79 are displayed on the display panel 23, the principal image frames being associated with respectively the month groups. There are frame amount sub-images 75a, 76a, 77a, 78a and 79a as frame amount information on respectively the principal image frames 75-79 for representing numbers of image frames associated with the months. A shape of the frame amount sub-images 75a-79a is such as if they were located behind the principal image frames 75-79. A user is enabled easily to recognize the frame amount for each of the months.

Image frames of the personal history of the user can be displayed with keys of retrospection image frames, to facilitate remembrance of past events or incidents at the same time as record of personal scenes. Also, tags may be added to the image frames by use of the past events or incidents recorded in the retrospection image frames, to rearrange image data files of the image frames with good efficiency. Specifically, two or more users can have experience of commonly encountering the past events or incidents. For example, a husband may have an experience of having visited the World Exposition of 1970 where a wife has the same experience without expecting the presence of their future spouses. However, the husband and/or wife can rearrange and observe the image frames by association of the past events or incidents, so as to remember the personal scenes closely related to the past events or incidents. The use of the retrospection image frames facilitates and encourages recollection of developmental periods of photographing the personal scenes.

It is to be that the principal image frames 75-79 may be determined by other selecting manners. However, the principal image frames 75-79 can be the earliest one of image frames in the months or calendrical periods according to the dates. Also, the user 10 can select the principal image frames 75-79 solely according his or her intention. Furthermore, the user 10 can effect search of similar images, and can determine the principal image frames 75-79 by considering the closest similarity to the retrospection image frame 67 according to manual operation. Note that the graduations or smallest unit of calendrical time on the time axis 80 may one day in place of one month according to the above embodiment. Also, the graduations or smallest unit of calendrical time may be three months, ten days, one week, or any other suitable length.

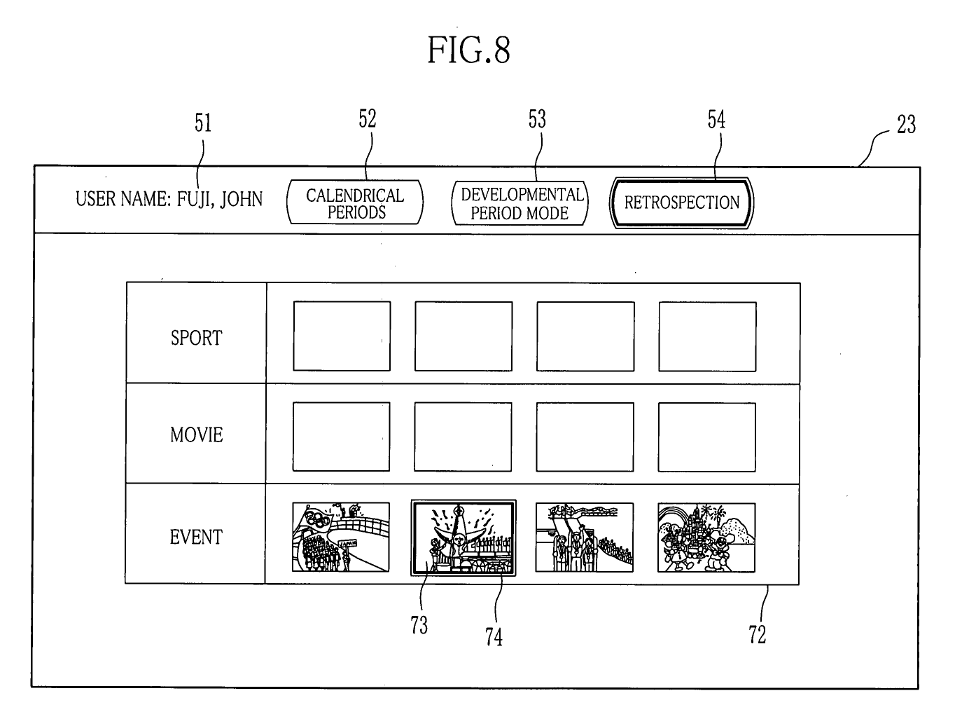

It is possible in another preferred embodiment to use an image server 25 of FIG. 1. When the retrospection image button 54 is clicked and selected, the image server 25 is accessed by the Internet or other suitable telecommunication systems, to selected one of retrospection image frames. The image server 25 stores database of data, which includes data files of retrospection image frames, and date information of dates of occurrence of the retrospection images. In FIG. 8, data in a retrospection image database storage 72 or featured image database storage are illustrated. When the user 10 accesses the image server 25, the display panel 23 is caused to display the data read from the retrospection image database storage 72. The retrospection image database storage 72 has plural image categories, such as sport, movie and event. A retrospection image frame 73 or featured image frame can be selected from any desired one of the image categories according to the intention of the user 10. A cursor key or cursor 74 as a pointing device of an operable input is shifted by the user 10, to click and selected one of the retrospection image frames 73.

In the above embodiment, borderlines between the developmental periods are changeably determined according to the birthdate information of the user. However, developmental periods can be preset differently between male and female users, and selectively determined according to input information of the user. Also, detailed user information can be recorded visibly on the user order form 24, such as a date of marriage anniversary, a birth of a child of the family, and the like, and can be utilized for sorting image frames in a more efficient manner.

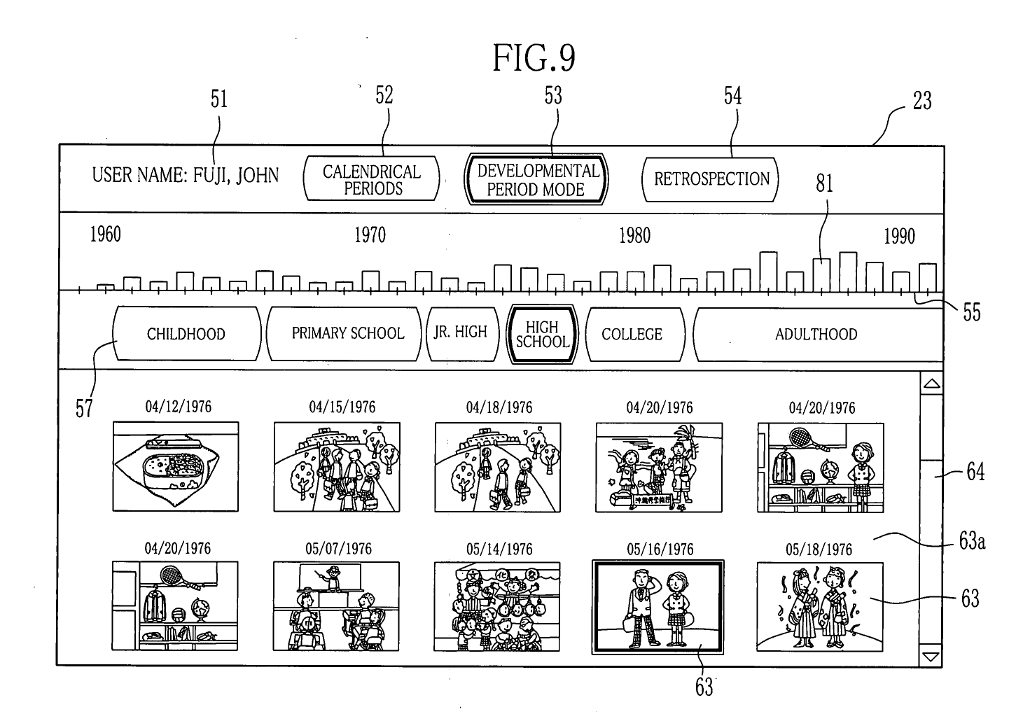

In the above embodiments, frame amount information of the numbers of the image frames are indicated in the developmental period buttons 57-62. However, the numbers as amount may be omitted. In FIG. 9, another preferred embodiment is illustrated, in which the developmental period buttons 57-62 does not have numbers as the frame amount information. Furthermore, a histogram 81 as frame amount information in a graph form is indicated above the time axis 55 to represent the frame amounts indirectly. Also, date information 63a is indicated near to the thumbnail image frames 63. It is to be noted that a school year of the user 10 can be indicated in place of the date information 63a, in such manners as HIGH SCHOOL 1^{ST} YEAR, COLLEGE 1^{ST} YEAR, and the like.

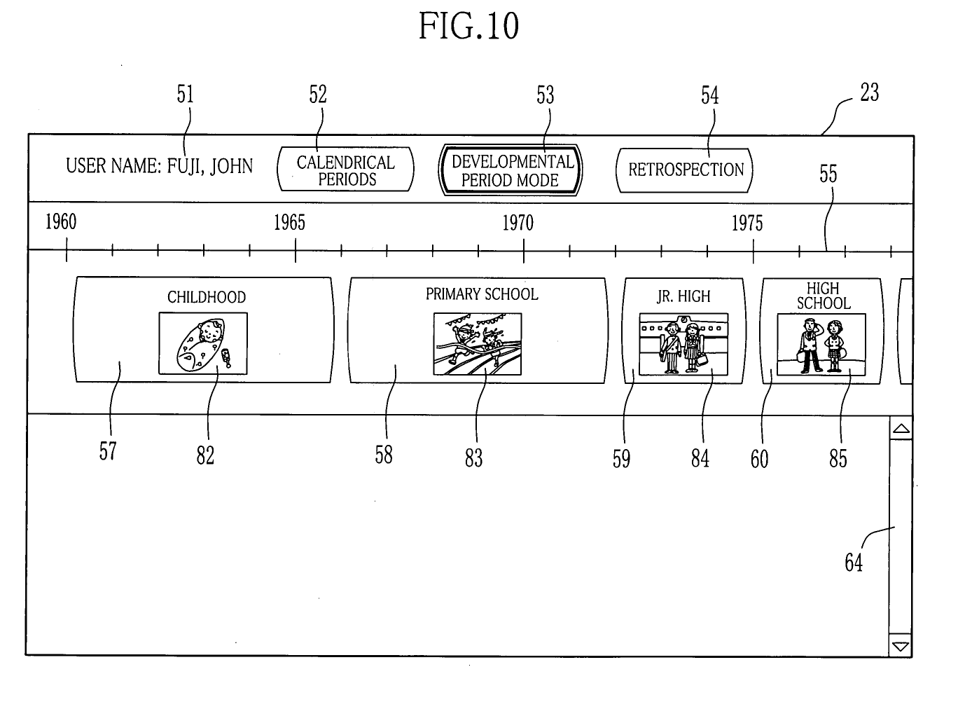

Also, principal image frames may be associated not with a regular period or month, but with the personalized developmental periods. In FIG. 10, a preferred embodiment is illustrated. Developmental period principal image frames 82, 83, 84 and 85 are displayed in enlarged regions of the developmental period buttons 57-60. This is effective in easy recollection of various past scenes of the plural developmental periods of the user 10.

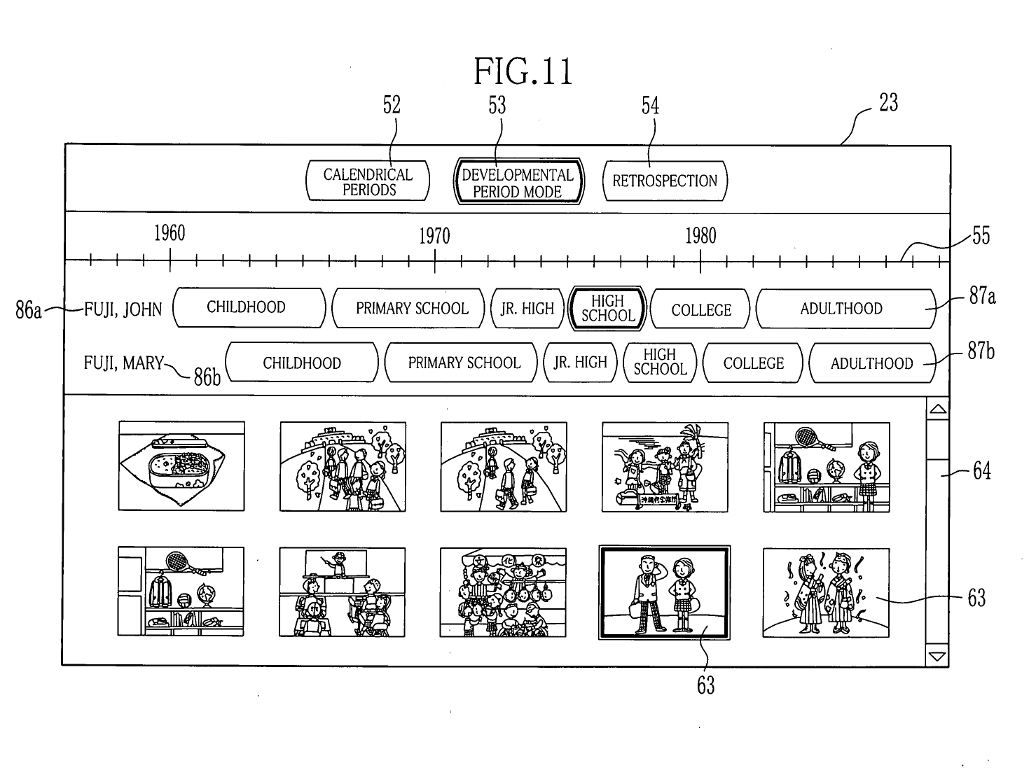

In the above embodiment, the user 10 is a single person. However, the displaying method and device of the invention may be modified for two users at the same time. In FIG. 11, a preferred embodiment is illustrated, in which there are two name regions for first user name information 86a (John Fuji) and second user name information 86b (Mary Fuji). Patterns of developmental period buttons 87a and 87b as developmental period information are displayed for the two users. In the user order form 24, names and birthdates of the two users are filled. At the digital imaging system 18, the information reader 34 reads the user information of the two users. The user information files of the users are written to the DVD 20. When the developmental period mode button 53 is clicked at the time of reproduction, the developmental period information of the users is detected according to a flow in FIG. 4. Data files included in the image data files 47 associated with the selected developmental period are derived by use of the index file 48, so the display panel 23 displays the thumbnail image frames 63.

In the above embodiments, the user order form 24 filled in with the user information is inserted in the user order package 16 and sent to the digital imaging system 18. However, it is possible by the Internet or suitable telecommunication systems to send the user information from the personal computer 22 to the digital imaging system 18. Furthermore, the present invention may be used in a system where the user 10 manually brings the user order package 16 to a receiving dealer or agent with the negative photo film 12 and the photographic prints 14, and the dealer or agent sends the user order package 16 to the digital imaging system 18. It is possible to fill in the user order form 24 with the user information at the time of bringing the user order package 16 to the receiving dealer or agent.

Note that chronological information of photography of an image frame is a date according to the above embodiment, but may be only a year, or a month and a year. Chronological information of the birth of a user is a date according to the above embodiment, but may be only a year, or a month and a year. If only the birth year is used, a birthdate is automatically determined as January 1 of the birth year. If only the birth month and birth year are used, a birthdate is automatically determined as a first day of the birth month.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An image displaying method, comprising steps of:
determining terms associated with respectively human developmental periods according to a birthdate, birth month or birth year of a user;
sorting image frames for said developmental periods according to chronological information of said image frames by referring to said terms, wherein image data of said image frames are stored in a storage medium, and said chronological information is stored in said storage medium in association with said image frames; and
reading image frames associated with a selected one of said developmental periods from said storage medium, so as to display said read image frames on a display panel.

2. An image displaying method as defined in claim 1, wherein information of said birthdate, birth month or birth year is stored in said storage medium.

3. An image displaying method as defined in claim 2, further comprising a step of displaying information of said developmental periods on said display panel in a selectable manner.

4. An image displaying method as defined in claim 3, further comprising a step of displaying a calendrical time axis on said display panel, said information of said developmental periods being arranged in association with said time axis.

5. An image displaying method as defined in claim 3, wherein said display panel is caused to display amount information of image frames associated with respectively said developmental periods.

6. An image displaying method as defined in claim 3, wherein said information of said developmental periods is in a form of a character.

7. An image displaying method as defined in claim 3, wherein a principal image frame is selected from said image frames associated with said developmental periods, and said information of said developmental periods is constituted by said principal image frame.

8. An image displaying method as defined in claim 3, wherein said time axis has a graduation pattern for representing a predetermined unit period.

9. An image displaying method as defined in claim 3, wherein said image frames of a plurality of users are stored in said storage medium, name information of said users is displayed on said display panel, and information of plural sets of said developmental periods of said users is displayed in association with said time axis.

10. An image displaying method as defined in claim 3, wherein featured image frames are previously stored in said storage medium for association of a calendrically fixed year, date or time thereof, and if a display mode related to said calendrically fixed year, date or time is designated, said featured image frames are selectively displayed on said display panel in association with said time axis.

11. An image displaying method as defined in claim 10, further comprising steps of:
selecting one of said featured image frames;
displaying information of plural unit periods on said display panel, said plural unit periods being determined on, and before or after, a calendrically fixed year, date or time of said selected featured image frame;
displaying at least one principal image frame on said display panel, said at least one principal image frame being derived from an image frame group obtained by sorting said image frames with said unit periods in consideration of said chronological information;
selecting one of said unit periods by referring to said principal image frame; and
displaying image frames on said display panel in association with said selected unit period.

12. An image displaying method as defined in claim 10, wherein said unit period is equal to or more than one month, and equal to or less than five years.

13. An image displaying method as defined in claim 1, wherein said image data are obtained by optical reading of said image frames on photo film or a photographic print, and said chronological information is obtained by reading from an information portion of said photo film or said photographic print.

14. An image displaying method as defined in claim 12, further comprising a step of displaying amount information of said image frames directly or indirectly on said display panel and for each of said predetermined unit periods or said terms.

15. An image displaying method as defined in claim 14, wherein said amount information of said image frames is in a number form, or indicated in a graph expression.

16. An image displaying method, comprising steps of:
determining terms associated with respectively human developmental periods according to a birthdate, birth month or birth year of a user;
displaying a first calendrical time axis and information of said developmental periods on a display panel, said first time axis having an original point defined by said birthdate, birth month or birth year, and being provided with information of a unit period, and said information of said developmental periods being arranged in association with said first time axis; and
displaying predetermined featured image frames on said display panel by reading said featured image frames from a storage medium, said featured image frames being arranged in association with said first time axis according to a calendrically fixed year, date or time assigned thereto.

17. An image displaying method as defined in claim 16, further comprising steps of:
selecting one of said plural featured image frames;
displaying a second calendrical time axis on said display panel, said second time axis being provided with information of plural partial unit periods, said plural partial unit periods being determined on, and before or after, a calendrically fixed year, date or time of said selected featured image frame;
sorting plural image frames with said partial unit periods in consideration of chronological information of said plural image frames, wherein said storage medium stores said plural image frames; and
displaying at least one principal image frame on said display panel in association with said second time axis, said at least one principal image frame being derived from an image frame group obtained by said sorting step.

18. An image displaying method as defined in claim 17, further comprising steps of:
selecting one of said plural principal image frames; and
displaying at least one image frame on said display panel among said image frames included in said image frame group of said selected principal image frame.

19. An image displaying method as defined in claim 18, wherein said first time axis has a graduation pattern for representing said unit period.

20. An image displaying method as defined in claim 18, wherein said unit period is equal to or more than one month, and equal to or less than five years.

21. An image displaying method as defined in claim 16, wherein information of said image frames is obtained by optical reading of photo film or a photographic print, and chronological information of said image frames is obtained by reading from an information portion of said photo film or said photographic print.

22. A program for displaying image frames on a display panel by reading of said image frames from a storage medium, said program being run in a computer, and comprising processes of:
determining terms associated with respectively human developmental periods according to a birthdate, birth month or birth year of a user;
sorting image frames for said developmental periods according to chronological information of said image frames by referring to said terms, wherein said chronological information is stored in said storage medium in association with said image frames; and
reading image frames associated with a selected one of said developmental periods from said storage medium, so as to display said read image frames on said display panel.

23. A program for displaying image frames on a display panel by reading of said image frames from a storage medium, said program being run in a computer, and comprising processes of:
determining terms associated with respectively human developmental periods according to a birthdate, birth month or birth year of a user;
displaying a calendrical time axis and information of said developmental periods on said display panel, said time axis having an original point defined by said birthdate, birth month or birth year, and being provided with information of a unit period, and said information of said developmental periods being arranged in association with said time axis; and
displaying predetermined featured image frames on said display panel by reading said featured image frames from said storage medium, said featured image frames being arranged in association with said time axis according to a calendrically fixed year, date or time assigned thereto.

24. An image displaying apparatus, including a display panel for displaying image frames, comprising:
a determining unit for determining terms associated with respectively human developmental periods according to a birthdate, birth month or birth year of a user;
a sorting unit for sorting image frames for said developmental periods according to chronological information of said image frames by referring to said terms, wherein said chronological information is stored in a storage medium in association with said image frames; and
a reading unit for reading image frames associated with a selected one of said developmental periods from said storage medium, so as to display said read image frames on said display panel.

25. An image displaying apparatus, including a display panel for displaying image frames, comprising:
a determining unit for determining terms associated with respectively human developmental periods according to a birthdate, birth month or birth year of a user;
a unit for displaying a calendrical time axis and information of said developmental periods on said display panel, said time axis having an original point defined by said birthdate, birth month or birth year, and being provided with information of a unit period, and said information of said developmental periods being arranged in association with said time axis; and
a unit for displaying predetermined featured image frames on said display panel by reading said featured image frames from a storage medium, said featured image frames being arranged in association with said time axis according to a calendrically fixed year, date or time assigned thereto.
